(19) United States
(12) Patent Application Publication
(10) Pub. No.: US 2026/0253931 A1
(43) Pub. Date: Aug. 27, 2026

(54) ORGANISM-BASED BIO-GENERATORS

(71) Applicants: Technion Research & Development Foundation Limited, Haifa (IL); Israel Oceanographic & Limnological Research Ltd. (PBC), Haifa (IL)

(72) Inventors: Noam ADIR, Haifa (IL); Gadi SCHUSTER, Haifa (IL); Yaniv SHLOSBERG, Haifa (IL); Alvaro Anibal ISRAEL, Hertzlyia (IL)

(73) Assignees: Technion Research & Development Foundation Limited, Haifa (IL); Israel Oceanographic & Limnological Research Ltd. (PBC), Haifa (IL)

(21) Appl. No.: 18/514,055

(22) Filed: Nov. 20, 2023

Related U.S. Application Data
(60) Provisional application No. 63/384,485, filed on Nov. 21, 2022.

(51) Int. Cl. H01M 8/16

(52) U.S. Cl. CPC H01M 8/16

(57) ABSTRACT

The invention generally contemplates electrodes and systems implementing same, wherein the electrode is provided with an oxygenic organism for generating electrical current.

### FIELD OF THE INVENTION

The present invention relates to a bio-generator utilizing live photosynthetic organisms.

### BACKGROUND OF THE INVENTION

In an age of ever progressive depletion of resources and environmental concerns, alternative energy sources are continuously sought. One approach is to develop means to directly harness the natural process of energy production used in photosynthetic organisms. Photosynthesis is the major source of useful chemical energy in the biosphere, occurring in plants, algae, and many species of bacteria. As is known in the art, the photosynthetic process includes two stages. In the first stage, light-dependent electron transfer reactions are utilized for proton gradient formation, which in turn is used to produce ATP and other reducing equivalents, such as NADPH. In the second stage, light-independent reactions use the products of the first stage to capture and reduce carbon dioxide.

During the first stage, light energy is absorbed by light harvesting antenna complexes containing pigment molecules. In plants, green and red microalgae and green, red or brown macroalgae, light is absorbed primarily using the pigment chlorophyll. In cyanobacteria, tetrapyrrole bilin chromophores also serve in antennas (known as phycobilisomes). Light energy, absorbed by the light harvesting antenna complexes, is transferred to photochemical reaction centers (RC), initiating charge separation on specific chlorophyll molecules bound to the RC proteins. Following charge separation, electrons are transferred sequentially to multiple acceptor molecules, each with a redox potential determined by its immediate environment. One common feature of all electron transfer pathways is the requirement for insulation of the redox active cofactors from potentially reducing/oxidizing molecules within the RC or in the surrounding media. Insulation provides the system with maximal electron transfer rates and efficiencies, and prevents damage to the RC.

The source of electron replenishment in a photosynthesis system differs according to the reaction center type. In purple non-sulfur bacteria, for example, electrons are cycled back to the reaction center by water-soluble electron carriers, for example, a cytochrome c type protein. In oxygenic photosynthetic organisms, including cyanobacteria, red and green algae and plants, most electron flow is non-cyclic, and occurs in two steps that involve two photosystems: Photosystem I (PSI) and Photosystem II (PSII). In such reactions, the deficit in electrons is replenished by electrons taken from water molecules (water oxidation). Under some light regimes, cyclic electron-transfer can occur around PSI, without water oxidation.

The initial steps of oxygenic photosynthetic electron transfer occur within PSII, which is a complex composed of proteins, pigments and cofactors, located within the thylakoid membranes. PSII has a redox potential of between 1.2V to 1.8V, required to extract electrons from water molecules. The process of electron transfer in PSII includes the following steps. Upon illumination, the P₆₈₀ chlorophyll is photoexcited. The photoexcited P₆₈₀ transfers electrons via intermediate cofactors called pheophytin a and plastoquinone A (PQ, Q_{A}) in order to doubly reduce a transiently bound PQ molecule (Q_{B}). Q_{B}²⁻ is protonated and released from the RC into the thylakoid membrane as PQH₂. The redox active cofactors that enable electron transfer from water to the secondary quinone acceptor Q_{B}, are mainly embedded within two proteins called D1 and D2. Under normal conditions of illumination, the DI protein of the RC core is irreversibly damaged over time and is replaced in a fashion that preserves the integrity of the PSII complex.

Electrons abstracted from water by PSII are transferred via the reduced PQH₂ to the cytochrome b₆/f complex. This reaction leads to the transfer of protons from the cytoplasm to the thylakoid lumen, which will be eventually used to obtain ATP via the proton-gradient (chemiosmotic) driven ATP synthase. Electrons are further shuttled via the plastocyanin (or soluble cytochrome C₆) to photoexcited Photosystem I (PSI). PSI then provides solar-driven electron transfer to a chain of electron acceptors eventually reducing soluble ferredoxin. This protein then shuttles the electrons to the Ferredoxin-NADP(+) reductase, leading to a flux of NADPH that serves as an electron providing substrate for a wide range of cellular synthetic pathways.

Synthetic and semi-synthetic systems based on photosynthetic processes have been proposed. These include various attempts to use dyes bound to solid-state materials and coupled molecules that form novel electron transfer pathways. Other examples of technologies for solar energy conversion include semiconductor/liquid junction solar cells and photovoltaic cells. Systems based on natural biological material have also been proposed. However, one of the major limitations of direct use of photosynthetic organisms or their components for solar energy conversion is that natural biological material has a relatively short functional lifetime. The use of biological material for energy production is mostly limited to the production of bio-fuels—photosynthetic organisms, such as plants, green algae and cyanobacteria, are grown for their biomass, which is then converted to fuel materials, for example, (bio)ethanol or (bio)diesel.

### SUMMARY OF THE INVENTION

There still remains a need for a cost effective, non-polluting system which enables conversion of sunlight to electrical energy. The inventors of the technology disclosed herein have developed such a system which allows harvesting electrical current directly from oxygenic photosynthetic organisms, such as macroalgae (seaweed and kelp) and plants of different leaf type. Harvesting of the current is made possible by use of a current generating device such as a photoelectrochemical cell or a bio-photoelectrochemical cell (BPEC) that may be designed or configured based on an external morphology of the organism species used. The BPEC generally comprises an electrode assembly, i.e., comprising an anode, a cathode and optionally a reference electrode, wherein an electrode of the electrode assembly, e.g., the anode, is associated with or provided with a photosynthetic organism that is in direct contact with an active region of the electrode. The electrode assembly is configured for generating current when immersed in an electrolyte solution. Upon illumination of the BPEC, NADPH flux and potentially flux of other possible molecules (generated during photosynthesis) is harvested by the organism-associated electrode, e.g., anode. Electrons that flow through the BPEC can be used directly as electrical current or can be used to reduce different compounds to form energy rich, storable fuels.

Thus, an electrode of the invention as a system implementing such an electrode may be used for generating electrical current, which may be stored or used in a variety of energy-based applications.

In one of its aspects, the invention provides an electrical conductor that is surface associated with an oxygenic photosynthetic organism, wherein the conductor is configured and operable for generating an electric current. The electrical conductor may be provided in a form of an electrode member that is surface-provided (or surface associated) with the oxygenic photosynthetic organism, wherein the electrode may be configured for assembly in a current generating device such as an electrochemical device.

Also provided is a device, e.g., an electrochemical device, that is configured for generating electrical current upon illumination with visible light, the device comprising an anode surface-provided (or surface-associated) with an oxygenic photosynthetic organism.

Further contemplated is a device comprising an electrode assembly configured and operable in an electrolyte solution or provided in an electrolyte solution and an oxygenic photosynthetic organism, wherein the electrode assembly comprises an anode and a cathode and optionally a reference electrode and wherein the organism is in direct contact with the anode surface and with the electrolyte solution.

The invention further provides a device for generating electrical current, the device comprising an electrode assembly provided in an electrolyte solution containing oxygenic photosynthetic organism, wherein an anode electrode of said electrode assembly is in direct contact with the organism.

The invention further provides a bio-electrochemical cell (BEC), the BEC comprising a cell or a container configured for receiving and holding an electrolyte solution and an oxygenic photosynthetic organism, the cell being equipped or provided with an electrode assembly, wherein an active surface of an anode of said electrode assembly is positioned to be in direct contact with the organism.

As used herein, the “bio-electrochemical cell (BEC)”, referred to also as a device or a system of the invention, is a device that is configured to convert biochemical energy into electrical energy following illumination of an oxygenic photosynthetic organism, or for some of the organisms that are grown in the absence of illumination, and which are provided in a contacting interaction with an anode electrode thereof. Within the bio-electrochemical cell, the organism undergoes photosynthesis generating NADPH flux. Electrons are received by the anode, through which the electrons are introduced into an electrical circuit, e.g., for collecting energy. The BEC may be provided as a single unit device comprising a pair of electrodes, or in a form of an array comprising a plurality of such BEC units, as disclosed herein.

The “oxygenic photosynthetic organism” (exchangeable with organism) is an organism capable of utilizing water as an electron source for generating oxygen and carbohydrates (from fixed CO₂) as the end products of photosynthesis. The photosynthetic organism may be provided intact, namely in a form that comprises all necessary organism functionalities (organelles) needed for carrying out photosynthesis, and in a form that permits the organism to carry out photosynthesis. The organism may thus be alive and intact. The organism may be selected amongst macroalgae and land plants of different leaf types. The organism is not cyanobacteria or is not microalgae or is not a succulent.

In some embodiments, the organism is a land plant and the oxygenic photosynthetic organism is any part of the plant capable of photosynthesis, including leaves. The land plant may be of any leaf type and may be any of the terrestrial plants known. The land plant may be, for example, any tree, shrub, vine, grass and herbaceous plant. Non limiting examples include origanum, cistus, pine, grapevine, rose, banana, Opuntia Ficus-indica, mosses and others.

In some embodiments, the organism is an aquatic plant, namely plants which leaves are found fully or partially under water, in the sea or within ponds, lakes, rivers, marshes or swamps. In some embodiments, the organism is an aquatic microorganism such as macroalgae.

In some embodiments, the oxygenic photosynthetic organism is seaweeds, kelp or aquatic green plant tissues.

In some embodiments, the macroalgae is a green macroalgae, e.g., Ulva macroalgae or sea lettuce, such as Ulva lactuca.

In some embodiments, the green macroalgae is selected amongst Chlamydomonas, Dunalliela salina, and Chlorella. In some embodiments, the green macroalgae is seaweed.

In some embodiments, the macroalgae is a red macroalgae, e.g., Porphyra, Kapaphycaus, Gelidium, Gracilaria, or Chondrus.

In some embodiments, the macroalgae is a brown macroalgae, e.g., Hizikia or Laminaria, such as Laminaria japonica. In some embodiments, the brown macroalgae is kelp.

In some embodiments, the macroalgae is seaweed or kelp.

In some embodiments, the macroalgae is Ulva, Jania, Stypopodium, Cladophora, Gracilleria, Padina or kelp.

In some embodiments, the organism is an aquatic plant. Non-limiting examples include floating heart, water lily, lotus, water hyacinth, water clover, Farrot's feather, pickerel weed, fairy moss and others.

As used herein, “an electrode surface-provided with an oxygenic photosynthetic organism”, being in some embodiments an anode, is an electrode which at least part of its surface, an active region of the electrode surface or the complete electrode surface, is in a direct or intimate contact with the organism. The term “surface-provided” or “surface-associated” refers to a direct contact between the electrode surface and the organism. The contact need not include a physical association, nevertheless needs to be direct and continuous over time. In some configurations, the organism may be provided on the electrode surface by way of immersing or submerging the electrode into an aquatic environment which contains the aquatic organism. In such configurations, the electrode may be positioned within the aquatic environment to maintain a direct contact and optionally an uninterrupted contact with the organism. In other configurations, the organism may be secured to a surface region of the electrode in order to ensure direct contact and prevent detachment or prevent less than an intimate (namely direct) contact with the electrode surface.

The association may be by clamping the organism to the surface of the electrode, e.g., by a clamp element or a clip, by way of a band or a wire that maintains the organism in contact with the electrode, by way of a structured electrode having a shape that increases a surface contact with the organism, by way of an elongated electrode that may be wind or twine around the organism, by way of an elongated electrode onto which the organism may be grown, e.g., a conductive rope, or by way any other way which would increase contact surface with the particular organism used. In a system comprising two or more electrodes, each associated with a different organism, the electrodes and the form of association may be same or different.

In some configurations in which the organism is an aquatic organism, association between the aquatic organism, e.g., seaweeds, kelp, green plant, is achievable by a constant physical attachment or by a temporary collision of the organism with the anode, which contact or collision is achievable by water stream. To achieve a steady contact with the electrode, turbulence may be introduced into the system to cause a more rigorous flow of waters and thus a continuous contact between the organism and the electrode.

In other exemplary embodiments, the BEC is designed for green, brown or red macroalgae (seaweeds) such as Ulva, Jania, Stypopodium, Cladophora, Gracilleria, Padina or kelps. Such organisms contain either flat or branched multicellular appendages (thallus) to which a stainless-steel clip or an aluminum plate may serve as the anode.

In further exemplary embodiments, the BEC may be designed for aquatic plants (such as Lily or other similar plants), which contain either flat and broad leaves or thick cuticula covered appendages to which a conductor material such as a stainless-steel clip or aluminum plate or an iron rod or any other so-called electrode material may be associated to serve as the anode.

As exemplified, the electrode may take on any shape and form and the association between the electrode and the photosynthetic organism may vary and is unlimited.

In a device of the invention, the electrode assembly provided with the organism is provided in an electrolyte solution or in an electrolyte. As known in the art, an “electrolyte solution” is a medium which is electrically conducting through movement of ions present in the medium. The medium may thus contain soluble salts, acids, and bases which can dissociate into ions. The medium is typically a polar solvent, such as water. In some configurations, the electrolyte solution is selected based on the organism used or may be pre-made to meet certain structural or operational requirements. In other configurations involving aquatic organism or plants, the electrolyte solution may be or may be derived from natural waters in which the aquatic organism utilized lives. Where desired, a device of the invention may utilize water derived or obtained from naturally occurring aquatic waters, such as sea water, ponds, lakes, etc, provided that they contain sufficient electrolytes (selection and/or concentration) that allow for proper operation of the device of the invention. If such waters are not sufficiently electrolytic, they may be enriched or treated to include a proper selection and/or concentration of electrolytes.

Without wishing to be bound by specific examples, the electrolyte medium may be any such medium known in the art. Where sea waters or natural waters are concerned or are to be used, the waters may comprise different concentrations of dissolved salts comprising ions selected from chloride, bromide, fluoride, sodium, magnesium, sulfate, calcium, potassium, and others. The concentration of the ions may vary and is not limited in any way.

In some embodiments, an exogenous electron mediator may be present or may be added to the electrolyte solution. The exogenous mediator may be a native metabolite or a chemical that mediates electrons between the organism and the electrodes. Examples include NADPH, ferricyanide, vitamin B1, soluble quinones, and derivatives of these.

In some configurations of a device of the invention, the device is configured for installing directly in a natural aquatic surrounding comprising oxygenic photosynthetic organism(s). The electrolytic waters in which the organism lives may provide the electrolytic medium sufficient for achieving proper and efficient operation of the device or system. In similar configurations, the device may be configured for installation in an artificial aquatic environment formed in specially constructed enclosures or in open facilities. Thus, the “aquatic environment” in which a device of the invention may be installed in any body of water. The aquatic environment may be based on land or can be based in an open body of water, such as open sea or in open lakes, etc. The aquatic environment may comprise one or more of the organisms disclosed herein and further micro-organisms such as non-photosynthetic bacteria, yeast or roots. These may be naturally present in the aquatic environment or may be introduced thereto to further enable external electron transport to the anode or accept electrons at the cathode or as a source of bio-compounds that increase the electrolyte concentration or apply as nutrition supplements for inducing the growth of aquatic organisms.

In some embodiments, the aquatic environment naturally comprises aquatic organisms capable of photosynthesis, as defined, such as cyanobacteria, microalgae, seaweeds, kelp or aquatic green plants.

In some embodiments, the aquatic environment is a natural water system such as a lake, river, pool, sea or ocean or an artificial cultivation system.

In some embodiments, the aquatic environment comprises natural seawater or a medium compatible with cultivation of aquatic organism.

In some embodiments, the aquatic environment is an artificial cultivation system comprising seawater.

In some embodiments, the aquatic environment is an artificial cultivation system configured to continuously or periodically receive, e.g., by active flow means or circulation, seawater from a natural source or artificial water that is compatible with cultivation of the aquatic organisms.

The electrode assembly provided in devices of the invention comprises an anode that is typically provided with the organism, as disclosed, a cathode and optionally a reference electrode. Any of the electrodes used may be selected amongst those known and used in conventional electrochemical cells. In some embodiments, either of the electrodes is formed of a metal, carbon-based material (such as graphite), or a conductive polymer. While the anode and cathode are provided in the electrolyte solution containing also the organism, the reference electrode may be provided in the same electrolyte solution. In some cases, therefore, a semi-permeable membrane may be used to separate between the aqueous solutions. The membrane may be any membrane made of a porous material enabling the trafficking of ions and molecules that are capable of charge transfer.

Non-limiting examples of electrodes which may be used include copper electrodes, zinc electrodes, lead electrodes, silver electrodes, electrodes of metal alloys, electrodes comprising materials such as graphite, platinum, gold and rhodium and others as known in the art.

In some embodiments, the anode and/or cathode may comprise or may be coated with a material that catalyzes hydrogen production. Such a material may be platinum or palladium nanoparticles or an enzyme such as hydrogenase. Hydrogen gas evolved by the catalytic reaction may be collected by a hydrogen-compatible pipeline leading to a hydrogen storage container.

Devices of the invention may be constructed or configured or provided as an array or as an infrastructure comprising a plurality, e.g., between 2 and several thousand devices, spread over a large area of an aquatic environment, such as sea, lake, etc. Each of devices in the array or infrastructure may comprise an electrode, e.g., an anode, that is provided in contact with same or different aquatic organism, as defined. In such arrays or infrastructures, multiple pairs of anodes and cathodes are provided, each pair being connected in a row or in parallel. The complete array or infrastructure may be coupled directly to an electric infrastructure to supply electricity or to capacitors or to rechargeable batteries that are to charge them. Alternatively or additionally, the array or infrastructure may be conjugated with solar energy, biofuel, or any technology that uses the conversion of physical power of the water flow in the cultivation container or natural water flow or waves into energy.

In some configurations of an array or an infrastructure, the array or infrastructure is configured for implementation in a land artificial cultivation facility comprising one or more vessels or pools or containers for growing or cultivating the aquatic organism. In some embodiments, the facility is exposed to direct sunlight or is provided with suitable artificial (sun)light. In some configurations, each of the vessels or pools or containers are equipped with solar cells that are conjugated to the array or each of the devices making up the array.

The invention further provides a process for generating electrical current, the process comprising illuminating by sunlight or visible light or an artificial (sun)light an oxygenic photosynthetic organism provided on a surface of an electrode, e.g., an anode, in an electrochemical device comprising an electrolyte solution.

Also provided is a process for generating electrical current, the process comprising
providing a device comprising an electrode assembly provided in an electrolyte solution and an oxygenic photosynthetic organism, wherein an anode of the electrode assembly is provided in direct contact with the organism;
exposing the organism to visible light (solar radiation or an artificial light source) to thereby generate current.

In some embodiments, the exposing of the organism comprises:
exposing for a period of time between several minutes to several hours or days or more;
exposing the organism at room temperature or at an optimal growth temperature of the specific organism; and/or
exposing when the organism is fully or partially immersed in an electrolyte medium.

The invention further provides a process for generating electrical current, the process comprising:
in a bio-electrochemical cell (BEC) comprising an electrode assembly in an electrolyte solution, associating or causing direct contact between an oxygenic photosynthetic organism and an anode of said assembly; and
illuminating or exposing the organism to visible light.

As explained herein, upon illumination of the organism in the device or BEC, NADPH flux may be harvested by the anode (being made, for example, of a metallic or a carbon, a polymeric or a conductive biomaterial), held at minimal potential with respect to cathode (being optionally a metallic or a carbon cathode). Electrons that flow through the device or BEC can be used directly as electrical current or can be used to reduce different compounds to form energy rich, storable fuels, etc.

The invention further provides:

An electrode surface-provided with an oxygenic photosynthetic organism, wherein the electrode is configured for assembly in an electrochemical device.

An electrochemical device configured for generating electrical current upon illumination with visible light, the device comprising an anode surface-provided with an oxygenic photosynthetic organism.

An electrochemical device configured for generating electrical current in the dark or under low visible light, the device comprising an anode surface-provided with an oxygenic photosynthetic organism.

A device comprising an electrode assembly provided in an electrolyte solution and an oxygenic photosynthetic organism, wherein the electrode assembly comprises an anode and a cathode and optionally a reference electrode and wherein the organism is in direct contact with the anode surface and with the electrolyte solution.

A device for generating electrical current, the device comprising an electrode assembly provided in an electrolyte solution and an oxygenic photosynthetic organism, wherein an anode electrode of said electrode assembly is in direct contact with the organism.

A bio-electrochemical cell (BEC), the BEC comprising an electrode assembly provided in an electrolyte solution and an oxygenic photosynthetic organism, wherein an anode of said assembly is provided in direct contact with the organism.

In a device according to the invention, the oxygenic photosynthetic organism is an organism capable of utilizing water as an electron source for generating oxygen and carbohydrates.

In a device according to the invention, the photosynthetic organism is provided in a form comprising necessary organism functionalities for carrying out photosynthesis.

In a device according to the invention, the photosynthetic organism is selected from macroalgae and plants of different leaf type.

In a device according to the invention, the photosynthetic organism is not cyanobacteria or is not microalgae.

In a device according to the invention, the photosynthetic organism is seaweeds, kelp or aquatic green plant tissues.

In a device according to the invention, the photosynthetic organism is a land plant or an aquatic plant or aquatic organism.

In a device according to the invention, the device is configured for installing in a natural aquatic surrounding comprising the oxygenic photosynthetic organism(s).

In a device according to the invention, the device is configured for installing in an artificial aquatic surrounding comprising the oxygenic photosynthetic organism(s).

In a device according to the invention, the artificial aquatic surroundings is n artificial aquatic system configured to continuously or periodically receive seawater from a natural source or artificial water compatible with cultivation of the aquatic organisms.

An array or an infrastructure comprising at least one device according to the invention.

In an array according to the invention, the array is configured for implementation in a land artificial cultivation facility comprising one or more vessels or pools or containers for growing or cultivating the aquatic organism.

In an array according to the invention, the facility is exposed to direct sunlight or is provided with suitable artificial light.

In an array according to the invention, each of the vessels or pools or containers are equipped with solar cells conjugated to the array or each of the devices comprised in the array.

A process for generating electrical current, the process comprising illuminating by visible light an oxygenic photosynthetic organism provided on a surface of an electrode in an electrochemical device comprising an electrolyte solution.

A process for generating electrical current, the process comprising
providing a device comprising an electrode assembly provided in an electrolyte solution and an oxygenic photosynthetic organism, wherein an anode of the electrode assembly is provided in direct contact with the organism;
exposing the organism to visible light (solar radiation or an artificial light source) or maintaining the organism under limited exposure to visible light or in the dark, to thereby generate current.

In a process of the invention, the exposing of the organism comprises:
exposing for a period of time between several minutes to several hours or days or more;
exposing the organism at room temperature or at the optimal growth temperature of the specific organism.
exposing when the organism is fully or partially immersed in an electrolyte medium.

A process for generating electrical current, the process comprising:
in a bio-electrochemical cell (BEC) comprising an electrode assembly in an electrolyte solution, associating or causing direct contact between an intact oxygenic photosynthetic organism and an anode of said assembly; and
illuminating or exposing the organism to visible light.

Also provided is an electrical conductor surface-associated with an oxygenic photosynthetic organism, wherein the conductor is configured for assembly in an electrochemical device, and wherein the organism is optionally a macroalgae.

An electrochemical device is also provided that is configured for generating electrical current upon illumination with visible light, the device comprising an anode surface-associated with an oxygenic photosynthetic organism, optionally being a macroalgae.

In some configurations, the BEC comprising an electrode assembly provided in an electrolyte solution and an oxygenic photosynthetic organism, wherein an anode of said assembly is provided in direct contact with the organism.

In some configurations, the oxygenic photosynthetic organism is an organism capable of utilizing water as an electron source for generating oxygen and carbohydrates.

In some configurations, the photosynthetic organism is provided in a form comprising organism functionalities for carrying out photosynthesis.

In some configurations, the photosynthetic organism is macroalgae, seaweed and/or kelp.

In some configurations, the system is configured for installing in a natural aquatic surrounding or in an artificial aquatic surroundings comprising the oxygenic photosynthetic organism(s).

In some configurations, the artificial aquatic surroundings is an artificial aquatic system configured to continuously or periodically receive seawater from a natural source or artificial water compatible with cultivation of seaweed or kalp.

Also provided is an array or an infrastructure comprising at least one device according to the invention.

In some configurations, the array is configured for assembly in natural waters selected from sea, lakes and ponds.

In some configurations, the array is configured for implementation in a land artificial cultivation facility comprising one or more vessels or pools or containers for growing or cultivating the aquatic organism.

In some configurations, the facility is exposed to direct sunlight or is provided with suitable artificial light.

In some configurations, each of the vessels or pools or containers is equipped with solar cells conjugated to the array or each of the devices comprised in the array. Also provided is a process for generating electrical current, the process comprising illuminating by visible light or artificial light an oxygenic photosynthetic organism provided on a surface of an electrode in an electrochemical device comprising an electrolyte solution.

In some configurations, the electrolyte solution is artificial aquatic surroundings or natural waters.

In some configurations, the organism is seaweed or kelp.

In some configurations, the process comprising
providing a device comprising an electrode assembly provided in an artificial aquatic surroundings or natural waters containing seaweed and/or kelp, wherein an anode of the electrode assembly is provided in direct contact with the seaweed and/or kelp;
exposing the seaweed and/or kelp to visible light to thereby generate current.

In some configurations, the device is a plurality or an array of electrical conductors, each being surface-associated with or in contact with same or different oxygenic photosynthetic organism present in said artificial aquatic surroundings or natural waters.

In some configurations, the electrode is associated with or inserted into or attached to the macroalgae surface, by any means disclosed herein.

In some configurations, a process of the invention is contemplated for generating hydrogen gas.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-C provide: FIG. 1A—A depiction of a seaweed-based bio generator in a cultivation tank on the beach. FIG. 1B—A schematic depiction of a basic seaweed-based bioelectrochemical cell. FIG. 1C—a photo of a seaweed-based cell.

FIG. 2 depicts a multiple seaweed-based bio generators connected in a row or in parallel.

FIGS. 3A-B provide FIG. 3A—depicts a seaweed-based bio generator in the open sea/ocean. FIG. 3B—depicts Kelp-based bio generator in the open sea/ocean.

FIG. 4 demonstrates an anode placement in kelp-based bio generator.

FIG. 5 depicts a plant-based bio generator in a cultivation tank on the beach.

FIG. 6A-B provide a description of a system and CA and hydrogen production measurement. FIG. 6A—provides a schematic drawing of the measurement setup which is composed of a stainless-steel clip as anode, platinum counter electrode cathode and Ag/AgCl 3M NaCl reference electrode (RE) dipped in 50 mL electrolyte solution. A solar simulator is placed horizontally to illuminate a round Ulva leaf (diameter=1 cm) with an intensity of 1 SUN. FIG. 6B provides CA measurements of bleached and green Ulva were measured in dark and light for 10 min. The onset of the light was at 0 min). CA of naturally bleached Ulva in light (BL), green Ulva in dark (D, red) and green Ulva in light (L). In some cases, a thick layer of parafilm served to isolate the evolved hydrogen, which was removed by an airtight syringe and quantified by GC. The inset shows hydrogen production after 10 min of bleached Ulva in light (BL), green Ulva in dark (D, red) and green Ulva in light (L). The error bars represent the standard deviation over 3 independent measurements. Small leakages of hydrogen may occur through the parafilm, so the actual hydrogen evolution rate may be slightly greater than reported.

FIGS. 7A-F provide photocurrent and DO measurements of macroalgae from various taxonomic groups. CA and DO were measured for the 6 different macroalgae in dark, light, and in light+100 μM DCMU. CA and DO measurements of FIG. 7A Ulva, FIG. 7B Jania, FIG. 7C Stypopodium, FIG. 7D Cladophora, FIG. 7E Gracilaria, and FIG. 7F Padina. In all panels, the left 3 green represents the current density after 10 min and the right blue Y-axis represents the change in DO quantities after 10 min. The error bars represent the standard deviation over 3 independent measurements. The names and photos of the macroalgae are displayed in the panels.

FIGS. 8A-B provide intact spinach leaves produce photocurrent from Photosystem II in a BPEC. FIG. 8A-C A measured using a leaf disk. A maximal photocurrent of ~6.7+/−0.4 mA/cm² was obtained when the leaf disk was illuminated with white light. No significant current was obtained in either dark (D) or in the presence of DCMU. FIG. 8B—Maximal current production in the CA of spinach leaves in dark (D), light (L), and light+DCMU. The error bars represent the standard deviation over 3 independent measurements. FIG. 8C shows a bar chart.

FIG. 9 depicts photocurrent production of different plants.

FIGS. 10A-C demonstrate applicative renewable energy technologies. CA of a Lily leaf was measured directly from its native growth environment using the water in the Lily Pond as the electrolyte of the BPEC. FIG. 10A—Photo of the Lily-pond with the measurement setup. FIG. 10B—-An enlargement of the active area of the pond where the CA measurements were conducted. A stainless-steel clip anode grasps the Lily leaf. The cathode and reference electrodes are held by a sponge that floats on the water surface. FIG. 10C—CA measurements in the Lily Pond water connected (red) or floating in the pond water (black) between the anode and the leaf, the maximal current produced in without and with a connection between the anode and the leaf were 0.003 +/−0.002 and 0.017+/−0.005 mA/cm² respectively. The insert displays the maximal obtained currents over a 5-hr measurement. The error bars represent the standard deviation over 3 independent measurements.

### DETAILED DESCRIPTION OF THE INVENTION

### Electricity Production from Macroalgae

Cultivation Vat configurations

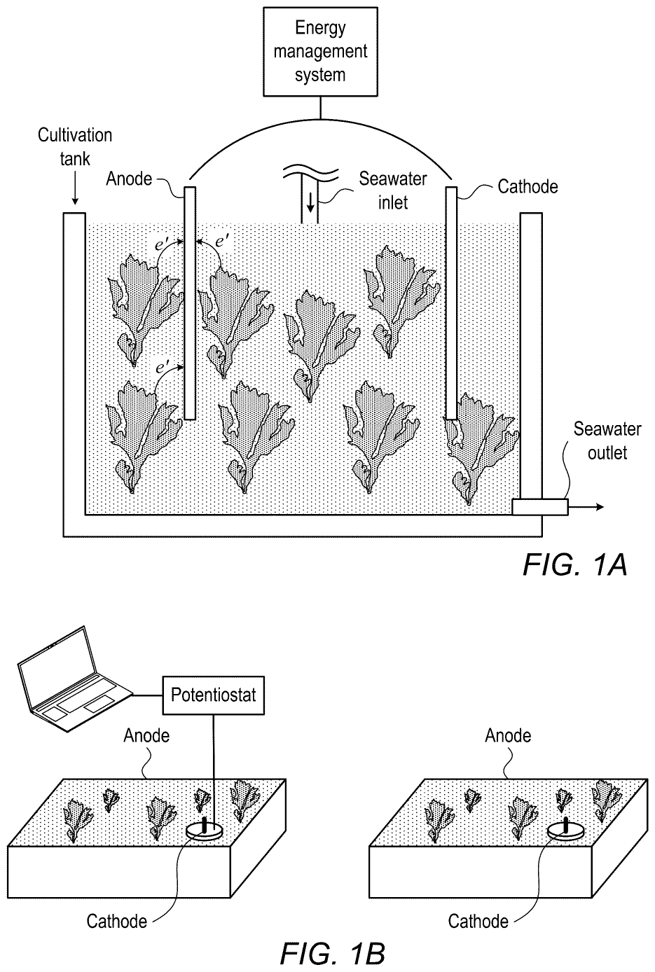

The basic macroalgal-based bio-electrochemical cell consists of a container with an aqueous solution with macroalgae and electrodes (anode, cathode, and or a reference electrode). The macroalgae are in a physical association with the electrodes. The macroalgae can then release reducing molecules that can donate electrons at the anode or accept electrons at the cathode. Electricity production occurs in the dark and is further enhanced in light by reducing molecules that originate from the photosynthesis pathway. The anode and the cathode are dipped inside the aqueous solution and are externally connected by conductive leads to form an electrochemical cell. This cell may be further connected to an energy management system. The electricity formed by the macroalgal-based bio-electrochemical cell can be directly used or applied for energy storage by charging a battery or a capacitor or producing hydrogen gas. A schematic representation of the basic system is shown in FIGS. 1A-B. A picture of this system is shown in FIG. 1C. In these figures, only 1 pair of anode+cathode is presented to simplify the visualization of the system. However, each vat may consist of multiple anodes, cathodes, and reference electrodes.

As depicted in FIG. 1A, seawater flow into the tank via the inlet and outside via the outlet by a pump. The tank contains seawater, waterborne seaweeds, an anode (or multiple anodes), and a cathode (or multiple cathodes). The anode and cathodes may have different shapes and are composed of a conductive material that may be a metal, polymer, or carbon-based material. The seaweeds physically touch the anode conducting electron transfer to it. The electrons continue from the anode to the cathode and further to electron exceptors in the seawater. The anode may consist of a noble metal or a different material that catalyzes hydrogen evolution. As shown in FIGS. 1B-C, macroalgae (seaweeds) are cultivated in seawater in large vats, illuminated by natural sunlight. An aluminum plate applies as the anode and a platinum wire is the cathode. Both are immersed in seawater. The macroalgae associate with the anode, creating a current that is measured by a computer-operated potentiostat (left panel). No added bias is applied in this BPEC architecture.

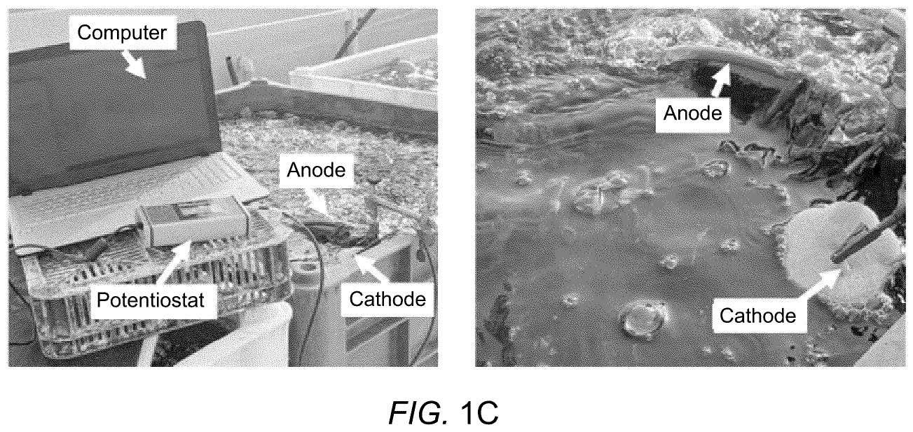

Multiple units of a basic bio-electrochemical system as described in FIG. 1A may be connected in a row or in parallel to enhance the generated electrical power (FIG. 2).

### Ropes in the Open Sea/Ocean Configuration

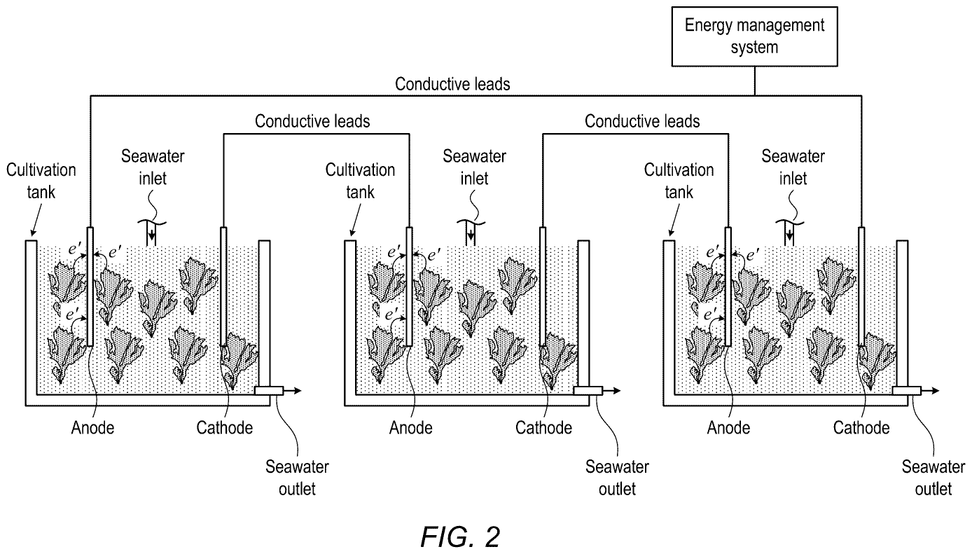

In this configuration, macroalgae are being cultivated in the sea or ocean directly on conductive ropes that apply as anodes. These ropes may be made of a conductive polymer, metal, or carbon-based material. The system consists of multiple system units of anodes with macroalgae growing on it, a cathode, and may also include a reference electrode. The units will be connected in a row or in parallel to enhance the generated electrical power. The multiple units will be also connected to an energy management system, and the produced electricity maybe be directly used or applied for energy storage by charging a battery or a capacitor or producing hydrogen gas. The macroalgal-based bioelectrochemical cells may consist of seaweeds (FIG. 3A) or kelp (FIG. 3B).

As demonstrated in FIG. 3A, seaweeds may be cultivated on ropes in the open seawater. The ropes are made of a conductive material such as a polymer, metal, or carbon-based material, and thus may be used as the electrodes. Multiple bioelectrochemical systems may be be connected in a row or parallel via conductive leads. The anode may consist of a noble metal or a different material that catalyzes hydrogen evolution. As shown in FIG. 3B, Kelp may be cultivated in the open sea/ocean. The anode may be placed in association with the kelp or will be inserted into the kelp. Cathodes may also be placed in the water. Multiple bio-electrochemical units (kelp+anode+cathode) may be connected in a row or parallel. The anode may consist of a noble metal or a different material that catalyzes hydrogen evolution.

Macroalgae with Internal Electrodes Configuration

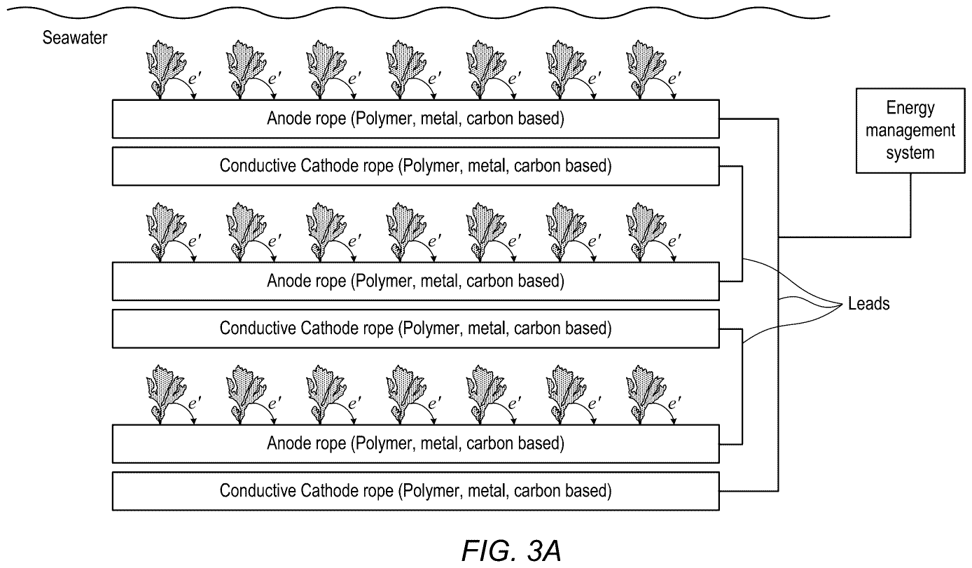

A modification of the system described in FIG. 3A-B may involve the insertion of the electrodes into the macroalgae instead or in addition to placing them in a physical association with the external surface of the macroalgae (FIG. 4).

Electricity Production from Plants Leaves

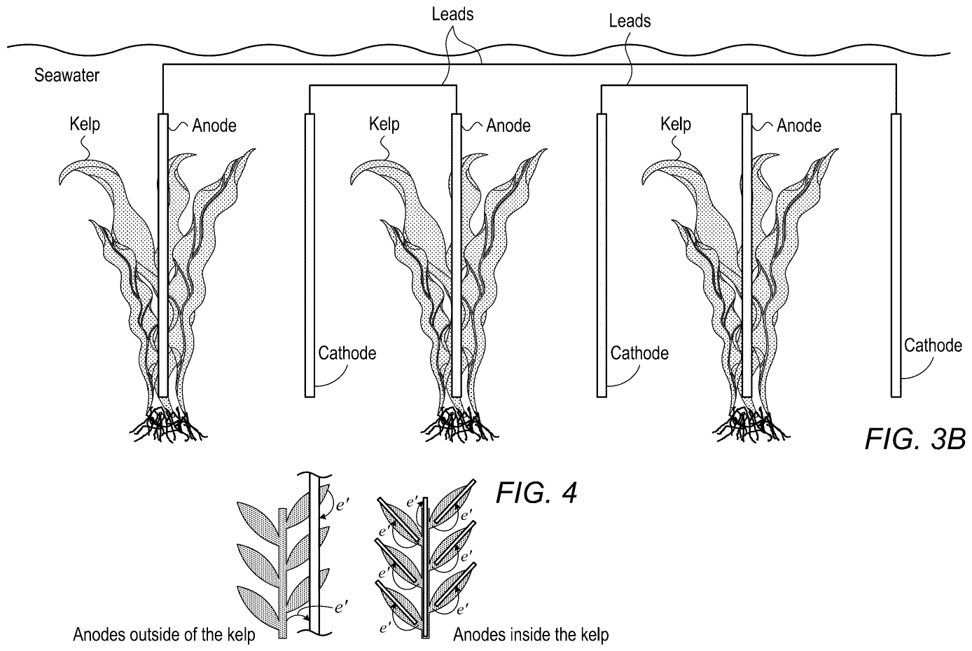

The system described in FIGS. 1-4 may be applied using intact or harvested leaves and stems instead of macroalgae. The natural or artificial aqueous solution may apply as an electrolyte. The electrode of the electrochemical cell may be physically associated with the plant's leaves or stems (FIG. 5). These electrodes may be physically associated with the other surface of the leaves/stems or inserted into them.

### Experimental Data

Photocurrent Production from Ulva Based BEC

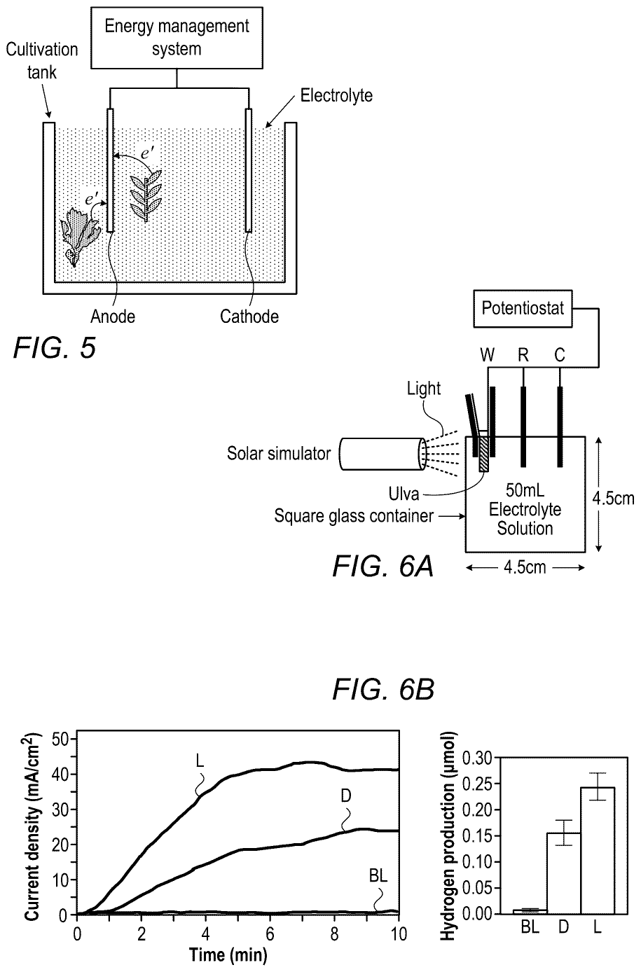

Ulva thallus cuttings were placed in the BPEC and the current harvested by the anode as measured by CA in 50 ml of a 0.5 M NaCl solution, with a bias potential of 0.5 V on the anode vs. Ag/AgCl 3M NaCl. Solar illumination with the intensity of 1 Sun (1000 W/m² ), a maximal current density of ~25 or ~40 mA/cm² was obtained after ~10 min of measurement in dark or light (FIG. 6).

As demonstrated in FIG. 6A, a measurement setup was composed of a stainless-steel clip as anode, platinum counter electrode cathode and Ag/AgCl 3M NaCl reference electrode (RE) dipped in 50 mL electrolyte solution. A solar simulator was placed horizontally to illuminate a round Ulva leaf (diameter=1 cm) with an intensity of 1 SUN. CA measurements of bleached and green Ulva were measured in dark and light for 10 min (FIG. 6B). The onset of the light was at 0 min). CA of naturally bleached Ulva in light (BL, black), green Ulva in dark (D) and green Ulva in light (L). In some cases, a thick layer of parafilm served to isolate the evolved hydrogen, which was removed by an airtight syringe and quantified by GC. The inset shows hydrogen production after 10 min of bleached Ulva in light (BL), green Ulva in dark (D) and green Ulva in light (L). The error bars represent the standard deviation over 3 independent measurements. Small leakages of hydrogen may occur through the parafilm, so the actual hydrogen evolution rate may be slightly greater than reported.

Photocurrent Production from Various Seaweeds Species

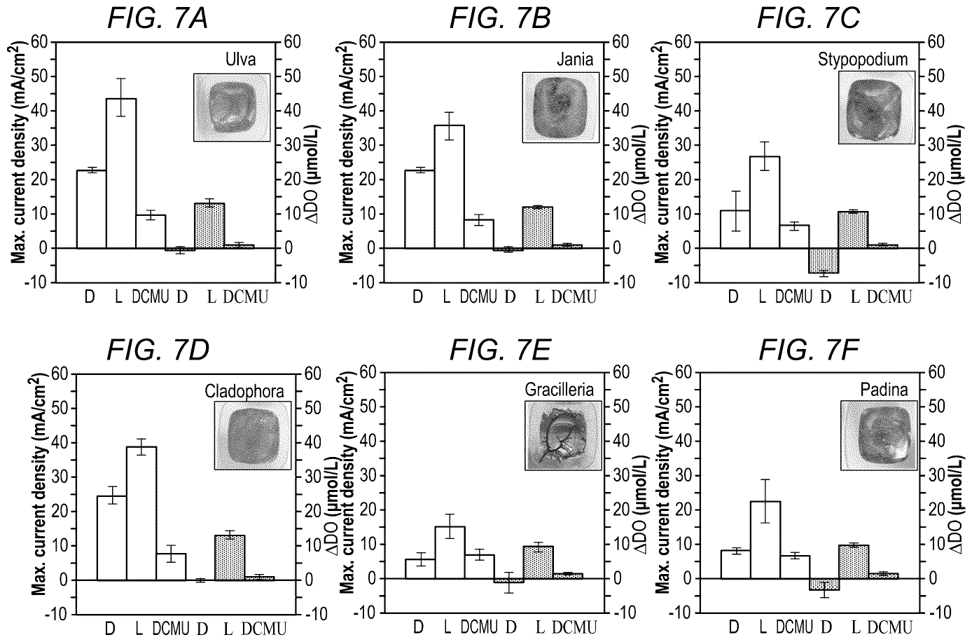

We collected environmental samples of red macroalgae Jania, brown macroalgae Padina and Stypopodium, and the green macroalgae Cladophora from the Eastern Mediterranean coast of Israel. Ulva and the red macroalgae Gracilaria were obtained from growth tanks. We performed CA measurements on all species as described above for Ulva. All macroalgae produced current, with maximal values of ~5-20, ~15-45, ~5-10 mA/cm2 in dark, light or light+DCMU, respectively (FIG. 7). Difference DO measurements reveal changes due to oxygen evolution (positive values) and mitochondrial respiration (negative values) showed a similar pattern for all macroalgae in which the difference DO concentration was ~−0.4-0, 0.4-0.6, and 0-0.05 mg/L in dark, light and light+DCMU, respectively (FIG. 7). Under illumination, the green macroalgae Ulva and Cladophora and the red macroalgae Jania produced photocurrents 2-2.7 times higher than the current produced from the brown macroalgae Stypopodium and Padina or the red macroalgae Gracilaria.

As shown in FIG. 7, CA and DO were measured for the 6 different macroalgae in dark, light, and in light+100 μM DCMU. CA and DO measurements of a Ulva, b Jania, c Stypopodium, d Cladophora, e Gracilaria, and f Padina. In all panels, the left 3 green represents the current density after 10 min and the right blue Y-axis represents the change in DO quantities after 10 min. The error bars represent the standard deviation over 3 independent measurements. The names and photos of the macroalgae are displayed in the panels.

Photocurrent Production from Spinach Based BEC

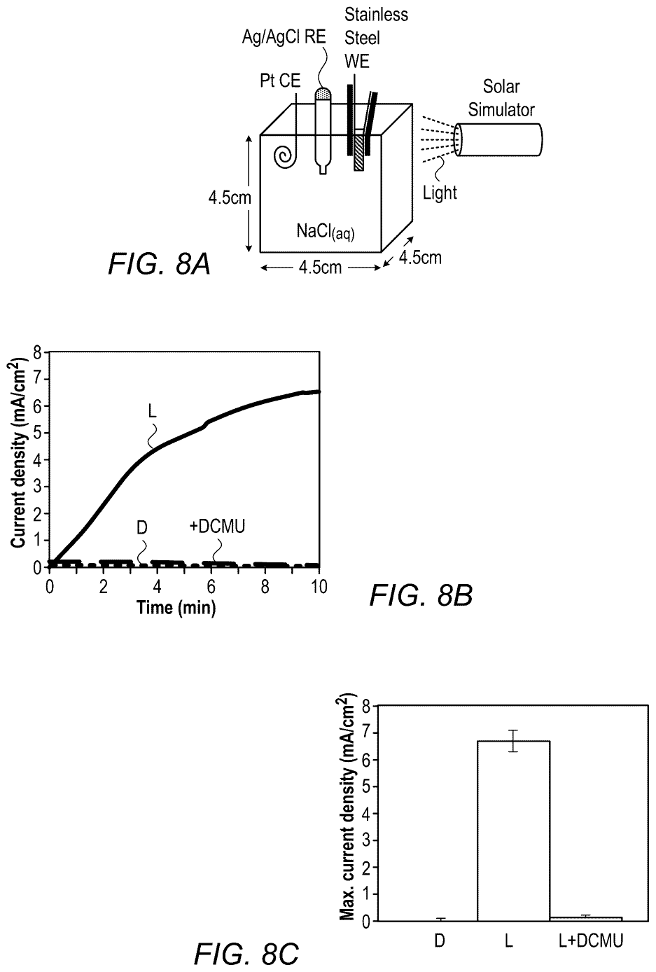

CA measurements were performed by directly connecting round segments of leaf from spinach (purchased at local markets) with a diameter of ~1 cm to the stainless-steel clip either in dark or light. The CA measurements were conducted with an applied bias potential of 0.5 V on the anode (FIG. 8A). When the leaf cutting is illuminated, the BPEC produced maximal photocurrents of 6.7+/−0.4 mA/cm2 after 10 min (FIG. 8B-C).

A maximal photocurrent of ~6.7+/−0.4 mA/cm2 was obtained when the leaf disk was illuminated with white light (FIG. 8A). No significant current was obtained in either dark (D) or in the presence of DCMU. Maximal current production in the CA of spinach leaves in dark (D), light (L), and light+DCMU (FIG. 8B). The error bars represent the standard deviation over 3 independent measurements (FIG. 8C).

Photocurrent Production from Various Plant Species

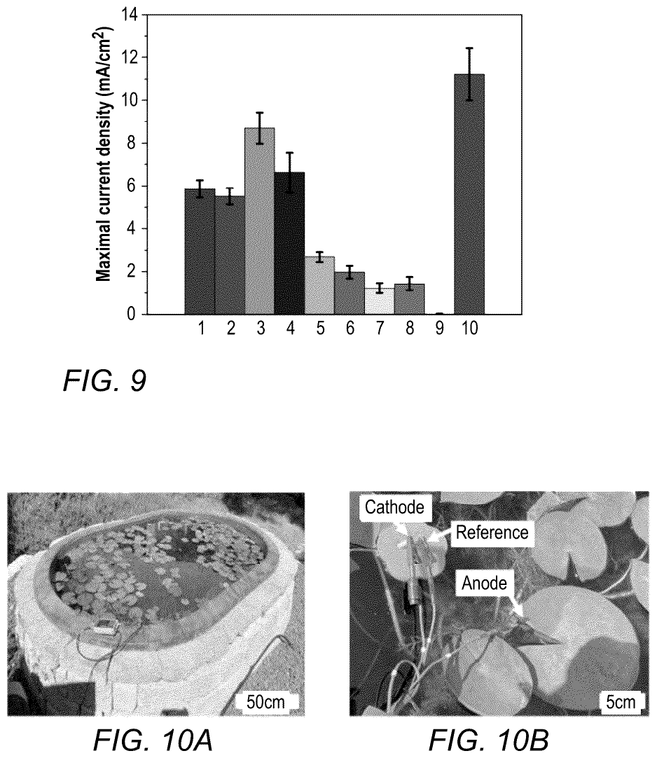

CA measurements were performed using leaves of various plants from different native habitats. We explored Salvia officinalis (Sage), Pinus (Pine needles), Cistaceae (Cistus), Salvia Rosmarinus (Rosemary), Vitis (Grapevine), Bryophyta (Moss), stems of Rosa (Rose) and the Cacti plant Opuntia Ficus-indica. Our results show that upon illumination, most leaves are able to generate an electric current in the BEC (FIG. 9), including leaves from trees, bushes, and the microphylls of moss. Planar leaves with soft textures produced ~6-9 mA/cm² while photosynthetic tissue (stems or leaves) with hard textures produced lower currents of ~1-2.5 mA/cm². No significant photocurrent could be obtained from intact Cacti plant Opuntia ficus-indica phylloclade (that consists of short photosynthetically competent stems). However, removal of its external rough layer enabled the harvesting of a photocurrent of ~11 mA/cm².

As shown in FIG. 9, CA of leaves and the stems of ten different plants were determined. Maximal current densities production of Sage 5.86+/−0.41 mA/cm² (1), Origanum 5.51+/−0.38 mA/cm² (2), Moss 8.69+/−0.73 mA/cm² (3), Cistus 6.62+/−0.93 mA/cm² (4), Pine 2.67+/−0.25 mA/cm² (5), Grapevine 1.96+/−0.3 mA/cm² (6), Rose stem 1.22+/−0.23 mA/cm² (7) Banana 1.43+/−0.31 mA/cm² (8), Opuntia ficus-indica 0.03 +/−0.02 mA/cm² (9) and Opuntia ficus-indica after removal of its cuticle 11.21+/−1.22 mA/cm² (10). The error bars represent the standard deviation over 3 independent measurements.

Photocurrent Production of from Water Lilies in their Native Pond

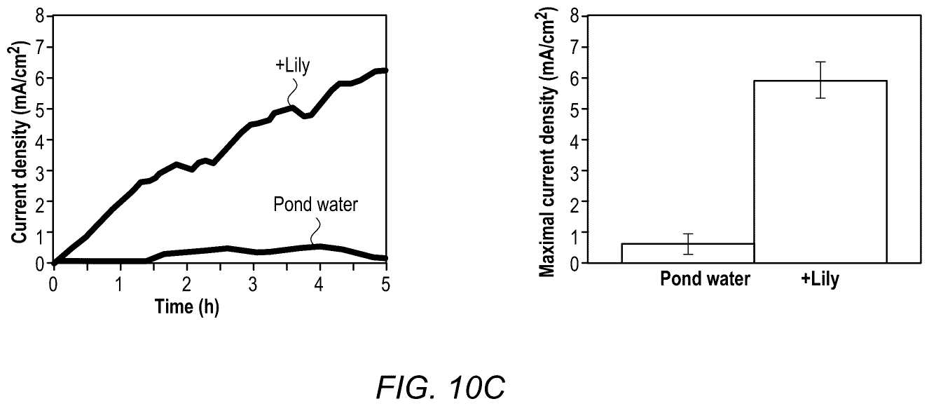

We examined the ability of Water Lilies (Nymphaeaceae) in their native pond to generate photocurrents under the natural sunlight. CA measurements were conducted in the pond under the naturally changing sunlight intensity using an applied bias of 0.5 V. A stainless-steel anode clip was dipped in the pool held one of the leaves in the pond. A platinum wire cathode and an Ag/AgCl KCl 3M were held by a sponge, to float on the pond surface (FIG. 10A-B). Sunlight intensities of ~200-900 μE/m²/s and water temperatures of 13-17° C. were measured during the duration of the CA measurement. Current densities of 6.5 mA/cm² was obtained in this configuration (FIG. 10). If the anode is not associated with a leaf only a small current (~0.5 mA/cm²) was obtained, most likely originating from corrosion or the existence of reducing molecules in the pond water.

### Seaweed Based BECs

### Macroalgae Cultivation, Sampling, and Sample Preparation

Ulva and Gracilaria thalli stocks were cultivated in land-based culture tanks as previously described (Qarri and Israel, 2020). Jania, Stypopodium, Padina, and Cladophora were collected from the intertidal zone in Achziv and Habonim field sites on the eastern Mediterranean Sea coast. For electrochemical and biochemical measurements, 1 cm diameter disks were excised from macroalgae with thallus structures: Ulva, Padina, and Stypopodium. The macroalgae Jania, Cladophora, and Gracilaria, all of whom have more complex morphologies, were excised from the larger tissues to an equivalent area of ~0.79 cm².

### Chronoamperometry Measurements

### Indoor CA Measurements

All indoor measurements were performed in 4.5 cm³ rectangular transparent glass vessels. Illumination was provided using a solar simulator (Abet, AM1.5G) placed horizontally to illuminate the macroalgae with a solar intensity of 1 Sun (1000 W/m2), keeping the distance between the simulator and the Ulva thallus at ~10 cm. Wavelengths in the ultraviolet range reaching the biological sample were minimal due to absorption by the glass and medium. The intensity of visible light reaching the macroalgae was measured as a function of distance from the light source in an empty vessel (neglecting small intensity losses caused by the glass and ~0.5 cm of the electrolyte solution). Bias-free electrochemical measurements were performed in a two-electrodes mode without application of electrical potential on the working electrode (WE, anode), using a stainless-steel clip as the WE and a Pt wire as the counter electrode (CE) in native seawater. All other indoor measurements were performed in three-electrodes mode using a stainless-steel clip as WE, a Pt wire as CE, and an Ag/AgCl 3M NaCl electrode as the reference electrode (RE, RE-1B, CH Instruments, USA) with an applied electric potential of 0.5 V on the WE in 0.5 M NaCl solution (unless otherwise stated). In all measurements, the current density was calculated based on the contact area between the WE and the macroalgae of 0.08 cm².

Direct CA Measurements from Ulva Cultivation Tanks

CA measurements were done directly from the pools using the lower part of a 37 cm aluminium plate as the WE, a Pt wire as the CE, and Ag/AgCl 3M NaCl as the RE, without added bias on the WE, under natural, fluctuating sunlight. Light intensity was measured by a light meter at the pool surface height. The Ulva float in the growth vat, associating and disassociating with the WE over the time of the measurements.

### Dissolved Oxygen Measurements

DO measurements were performed using a DO meter probe (Hanna Instruments, HI-5421 research-grade DO and BOD bench meter). The measurements were performed in the same experimental vessel as the CA measurements. The DO probe was inserted into the electrolyte solution and the top of the glass container was sealed tightly with multiple layers of parafilm. A small magnetic bar was used to stir the electrolyte solution.

### Flat Plants Based BECs

Materials. All chemicals were purchased from Merck. Spinacia oleracea leaves were purchased at local markets in Haifa.

Indoor CA measurements leaves. The indoor CA measurements of flat leaves were done in the same setup which was described in our previous work (Shlosberg et al., 2021b). The measurements of all leaves were done in a small rectangular transparent glass vessel with dimensions of 4.5 cm³ . A solar simulator (Abet, AM1.5G) was placed horizontally to illuminate the leaves with a solar intensity of 1 Sun (1000 W/m² ). Determination of the light intensity at the surface of the leaves was done as a function of distance from the light source in an empty vessel neglecting small intensity losses caused by the glass and (~0.5 cm) of the electrolyte solution. The measurements were conducted in 3 electrode mode (unless otherwise mentioned) using the stainless-steel clip as anode, a platinum wire as a cathode, and Ag/AgCl 3 M NaCl as a reference electrode (RE-1B, CH Instruments, USA) with an applied electric potential bias of 0.5 V on the anode in NaCl solution (0.5 M). In all measurements, the current density was calculated by subtraction of the stable baseline after ~10 min and based on the contact area between the anode and the leaves of 0.08cm² . When applied, the addition of 3-(3,4-dichlorophenyl)-1,1-dimethylurea (DCMU) was done prior to the measurements (5 min).

Hydrogen production and quantification. The BPEC was covered by a thick parafilm layer. The volume of the electrolyte solution was 50 mL and the headspace volume was 40 mL. Following 10 min of CA measurements, 1 mL of air was removed from the top of the reaction vessel and injected into vials (1.8 mL). Samples (50 L) were injected into a gas chromatograph (GC) system coupled with a thermal conductivity detector (GC-TCD, Agilent 8860) with a 5-Å column (Agilent, 25 m×0.25 mm×30 μm). Hydrogen that evolved during the BPEC stabilization stage (see previous section) were subtracted from the values of hydrogen obtained during the actual experiment.

Direct CA Measurements from the water lily pond. CA measurements were done directly from the pools using a stainless-steel clip anode, a Pt wire as a cathode, and Ag/AgCl 3 M NaCl as a reference electrode. The anode clip was grasping a waterlily leaf. The anode and reference electrode were inserted into a sponge that was floating on the pool surface. An applied electric potential of 0.5 V on the anode under the sunlight. Light intensity was measured at the water surface height of the pond with an app-based portable light meter Lux. The temperature was monitored manually during the duration of the measurement.

1. An electrical conductor surface-associated with an oxygenic photosynthetic organism, wherein the conductor is configured for assembly in an electrochemical device, and wherein the organism is macroalgae.

2. An electrochemical device configured for generating electrical current upon illumination with visible light, the device comprising an anode surface-associated with macroalgae.

3. The device according to claim 2 being a bio-electrochemical cell (BEC), the BEC comprising an electrode assembly provided in an electrolyte solution and macroalgae, wherein an anode of said assembly is provided in direct contact with the macroalgae.

4. The device according to claim 2, wherein the macroalgae is provided in a form comprising organism functionalities for carrying out photosynthesis.

5. The device according to claim 4, wherein the macroalgae is seaweed.

6. The device according to claim 4, wherein the macroalgae is kelp.

7. The device according to claim 2, configured for installing in a natural aquatic surrounding or in an artificial aquatic surroundings comprising the macroalgae.

8. The device according to claim 7, wherein the artificial aquatic surroundings is an artificial aquatic system configured to continuously or periodically receive seawater from a natural source or artificial water compatible with cultivation of seaweed or kelp.

9. An array or an infrastructure comprising at least one device according to claim 2.

10. The array or infrastructure according to claim 9, configured for assembly in natural waters selected from sea, lakes and ponds.

11. The array or infrastructure according to claim 9, configured for implementation in a land artificial cultivation facility comprising one or more vessels or pools or containers for growing or cultivating the aquatic organism.

12. The array or infrastructure according to claim 11, wherein the facility is exposed to direct sunlight or is provided with suitable artificial light.

13. The array or infrastructure according to claim 11, wherein each of the vessels or pools or containers is equipped with solar cells conjugated to the array or each of the devices comprised in the array.

14. A process for generating electrical current, the process comprising illuminating by visible light or artificial light macroalgae provided on a surface of an electrode in an electrochemical device comprising an electrolyte solution.

15. The process according to claim 14, wherein the electrolyte solution is artificial aquatic surroundings or natural waters.

16. The process according to claim 14, wherein the macroalgae is seaweed or kelp.

17. The process according to claim 14, the process comprising
providing a device comprising an electrode assembly provided in an artificial aquatic surroundings or natural waters containing seaweed and/or kelp, wherein an anode of the electrode assembly is provided in direct contact with the seaweed and/or kelp;
exposing the seaweed and/or kelp to visible light to thereby generate current.

18. The process according to claim 17, wherein the device is a plurality or an array of electrical conductors, each being surface-associated with or in contact with same or different macroalgae present in said artificial aquatic surroundings or natural waters.

19. The process according to claim 14, wherein the electrode is associated with or inserted into or attached to the macroalgae surface.

20. The process according to claim 18, for further generating hydrogen gas.
